(19) United States
(12) Patent Application Publication
(10) Pub. No.: US 2003/0005395 A1
(43) Pub. Date: Jan. 2, 2003

(54) Method and apparatus for determining optimum size of LSI chip

(76) Inventors: Kenichirou Chisaka, Hyogo (JP); Kouichirou Umeda, Hyogo (JP); Manabu Ishibashi, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/153,595

(22) Filed: May 24, 2002

(30) Foreign Application Priority Data
Jul. 2, 2001 (JP) 2001-201099

(51) Int. Cl. G06F 17/50

(52) U.S. Cl. 716/4

(57) ABSTRACT

An apparatus for determining the optimum size of a LSI chip of the present invention has the-theoretical-number-of-chips calculating means 5 calculating the theoretical number of chips according to a chip configuration in a mask calculated by in-the-mask-chip-configuration calculating means 3 and the information of wafer-line information holding part 4; the-number-of-transcriptions calculating means 6 calculating the number of transcriptions of a layout pattern on the mask to a wafer according to the chip configuration in the mask calculated by in-the-mask-chip configuration calculating means 3 and the theoretical number of chips calculated by the-theoretical-number-of-chips calculating means 5; and display part 9 that displays the calculated theoretical number of chips and number of transcriptions.

### BACKGROUND OF THE INVENTION

1. Field of the Invention

The present invention relates to a method and an apparatus for determining the optimum size of a LSI chip to determine the optimum size of a LSI chip when a LSI is designed in consideration of both a cost calculated from the theoretical number of chips and the throughput of wafer processing calculated from the number of transcriptions.

2. Description of the Prior Art

FIG. 16 is a configuration diagram showing a conventional apparatus for determining the optimum size of a LSI chip. Referring to the figure, LSI-chip-size-information holding part 1 has registered LSI chip sizes; in-the-mask-limitation-information holding part 2 holds the registered effective areas in each mask size; in-the-mask-chip-configuration calculating means 3 is used for calculating the chip configuration in the mask; wafer-line-information holding part 4 holds the registered effective area in a wafer line to be used; the-theoretical-number-of-chips calculating means 5 calculates the theoretical number of chips, and display part 9 displays held information and a calculated result.

FIGS. 17A. 17B are an explanatory drawing showing LSI chips in a conventional mask and wafer.

The operation will next be described.

As shown in FIG. 17A, a mask required for the LSI manufacturing consists of combined LSI chips and dicing lines, which will be cut on assembly, and have arranged alignment marks for wafer processing. As shown in FIG. 17B, the patterns on the mask are transcribed to the wafer in a step and repeat manner, and thereby spread over the wafer.

In the apparatus for determining the optimum size of a LSI chip showed in FIG. 16, in-the-mask-chip-configuration calculating means 3 inputs the size of the LSI chip, the wafer line name, and the mask size (for instance, 5-inch mask and 6-inch mask) from LSI-chip-size-information holding part 1 and the effective area, on which a transcription can be done in the mask, for each mask size from in-the-mask-limitation-information holding part 2, respectively, to thereby calculate the chip configuration in the mask according to the LSI chip size, the mask size, and the effective area in the mask. Herein, the chip configuration in the mask is defined as the chip arrangement in which, for instance, two LSI chips are placed in the X direction, and three LSI chips are placed in the Y direction.

Moreover, the-theoretical-number-of-chips calculating means 5 inputs the calculated chip configuration in the mask and the effective area in the wafer line from wafer-line-information holding part 4 (because the usable area in each wafer is different in the wafer line to be used, the area is described in the information.), to thereby determine the chip configuration in the wafer in the wafer line to be used. After that, the calculating means calculates the theoretical number of chips (the number of LSI chips), and displays the theoretical number of chips in display part 9, to thereby finish its job.

Because the conventional apparatus of determining the optimum size of a LSI chip is constructed as mentioned above, it is necessary, in order to reduce the LSI manufacturing cost, to minimize the number of the transcriptions of the pattern on the mask to the wafer (to prevent the wafer processing time from being increased because of an increase in the number of the transcriptions) by use of the chip size in which the theoretical number of chips is large.

However, in the conventional apparatus the designer could confirm the theoretical number of chips, but could not confirm the number of the transcriptions. As a result, there was the problem that he could not confirm the chip configuration in which the theoretical number of chips is large and further the number of transcriptions is minimum.

### SUMMARY OF THE INVENTION

The present invention has been accomplished to solve the above-mentioned problem. An object of the present invention is to provide a method and an apparatus for determining the optimum size of a LSI chip, using which a designer can confirm the theoretical number of chips and the number of transcriptions.

The method of determining the optimum size of a LSI chip according to the present invention comprises: an in-the-mask-chip-configuration calculating step in which a chip configuration in a mask is calculated according to information on LSI chip sizes; a the-theoretical-number-of-chips calculating step in which the theoretical number of chips is calculated according to the chip configuration in the mask calculated in the in-the-mask-chip-configuration calculating step and information on wafer lines; a the-number-of-transcriptions calculating step in which the number of the transcriptions of a layout pattern on the mask to a wafer is calculated according to the chip configuration in the mask calculated in the in-the-mask-chip-configuration calculating step and the theoretical number of chips calculated in the the-theoretical-number-of-chips calculating step; and a mark-location verifying step in which the propriety of mark location is verified according to the chip configuration in the mask calculated in the in-the-mask-chip-configuration calculating step and mark information organized by processing method.

An apparatus for determining the optimum size of a LSI chip according to the present invention comprises an in-the-mask-chip-configuration calculating means calculating a chip configuration in a mask according to information in a LSI-chip-size-information holding part; a the-theoretical-number-of-chips calculating means calculating the theoretical number of chips according to the chip configuration in the mask calculated by the in-the-mask-chip-configuration calculating means and information in a wafer-line-information holding part; a the-number-of-transcriptions calculating means calculating the number of transcriptions of a layout pattern on the mask to the wafer according to the chip configuration in the mask calculated by the in-the-mask-chip-configuration calculating means and the theoretical number of chips calculated by the the-theoretical-number-of-chips calculating means; a mark-location verifying means verifying the propriety of a mark location according to the chip configuration in the mask calculated by the in-the-mask-chip-configuration calculating means and information in a mark-information-organized-by-processing-method holding part; and a display part displaying any one of the above-described held information and the above-described calculated or verified result.

An apparatus for determining the optimum size of a LSI chip according to the present invention comprises: a transcription-information holding part in which the maximum value, the minimum value, and the step value of a transcription beginning coordinate in a wafer are registered; a transcription-beginning-coordinate calculating means calculating a transcription beginning coordinate according to a chip configuration in a mask calculated by the in-the-mask-chip-configuration calculating means and the information in the transcription-information holding part; and a for-each-transcription-beginning-coordinate continuously executing means continuously executing the the-theoretical-number-of-chips calculating means and the the-number-of-transcriptions calculating means for each transcription beginning coordinate calculated by the transcription-beginning-coordinate calculating means.

An apparatus for determining the optimum size of a LSI chip according to the present invention comprises: an actual-processing-information holding part in which a processing time for each transcription and the ratio of the total cost of the wafer processing to the cost of the photolithography process are registered; and a for-a-LSI-chip-size-evaluation-value calculating means calculating an evaluation value according to the theoretical number of chips calculated by the the-theoretical-number-of-chips calculating means, the number of transcriptions calculated by the the-number-of-transcriptions calculating means, and the information in the actual-processing-information holding part.

An apparatus for determining the optimum size of a LSI chip according to the present invention comprises: a ratio calculating means calculating the number of LSI chips in the wafer in which a problem for a LSI chip is caused when a transcription from a mask to a wafer is done according to a chip configuration in a mask calculated by the in-the-mask-chip-configuration calculating means and the information in the wafer-line-information holding part, to thereby calculate the ratio of the number of LSI chips in the mask to the number of LSI chips in the wafer in which the problem is caused; a ratio-information holding part in which the ratio information is registered; a the-limited-theoretical-number-of-chips calculating means calculating the theoretical number of chips within the limits according to the ratio calculated by the ratio calculating means and the information in the ratio-information holding part; a the-limited-number-of-transcriptions calculating means calculating the number of transcriptions within the limits according to the ratio calculated by the ratio calculating means and the information in the ratio-information holding part; and a for-each-transcription-continuously-executing means continuously executing the ratio calculating means, the the-limited-theoretical-number-of-chips calculating means, and the the-limited-number-of-transcriptions calculating means for each transcription.

An apparatus for determining the optimum size of a LSI chip according to the present invention comprises: a mark-location-priority-information holding part in which the priority of mark location for wafer processing, the number of marks for processing organized by process method, and the mark sizes are registered; and a for-each-mark-location-priority-continuously-executing means continuously executing the transcription-beginning-coordinate calculating means, the for-each-transcription-continuously-executing means, the for-a-LSI-chip-size-evaluation-value calculating means, and the mark-location verifying means for each priority in the mark location for wafer processing registered in the mark-location-priority-information holding part.

An apparatus for determining the optimum size of a LSI chip according to the present invention comprises: a the-combination-of-LSI-chip-sizes calculating means calculating the combination of LSI chip sizes according to the maximum value and the minimum value of LSI chip sizes, and the step values of LSI chips; and a for-each-combination-of-LSI-chip-sizes-continuously-executing means continuously executing the in the-mask-chip-configuration calculating means and the for-each-mark-location-priority-continuously-executing means for each combination of LSI chip sizes calculated by the the-combination-of-LSI-chip-sizes calculating means.

### BRIEF DESCRIPTION OF THE DRAWINGS

FIG. 1 is a configuration diagram showing the apparatus for determining the optimum size of a LSI chip according to Embodiment 1 of the present invention;

FIG. 2 is an explanatory diagram showing a display example displayed by the display part according to Embodiment 1 of the present invention;

FIG. 3 is a configuration diagram showing the apparatus for determining the optimum size of a LSI chip according to Embodiment 2 of the present invention;

FIG. 4 is an explanatory diagram showing a display example displayed by the display part according to Embodiment 2 of the present invention;

FIG. 5 is an explanatory drawing showing the relation between a wafer and a mask according to Embodiment 2 of the present invention;

FIG. 6 is a configuration diagram showing the apparatus for determining the optimum size of a LSI chip according to Embodiment 3 of the present invention;

FIG. 7 is an explanatory diagram showing a display example displayed by the display part according to Embodiment 3 of the present invention;

FIG. 8 is an explanatory diagram showing an actual processing according to Embodiment 3 of the present invention;

FIG. 9 is a configuration diagram showing the apparatus for determining the optimum size of a LSI chip according to Embodiment 4 of the present invention;

FIG. 10 is an explanatory diagram showing a display example displayed by the display part according to Embodiment 4 of the present invention;

FIG. 11 is an explanatory drawing showing a wafer sample according to Embodiment 4 of the present invention;

FIG. 12 is a configuration diagram showing the apparatus for determining the optimum size of a LSI chip according to Embodiment 5 of the present invention;

FIG. 13 is an explanatory diagram showing a display example displayed by the display part according to Embodiment 5 of the present invention;

FIG. 14 is a configuration diagram showing the apparatus for determining the optimum size of a LSI chip according to Embodiment 6 of the present invention;

FIG. 15 is an explanatory diagram showing a display example displayed by the display part according to Embodiment 6 of the present invention;

FIG. 16 is a configuration diagram showing a conventional apparatus for determining the optimum size of a LSI chip; and

FIGS. 17A, 17B are an explanatory drawing showing LSI chips in a conventional mask and wafer.

### DETAILED DESCRIPTION OF THE PREFERRED EMBODIMENTS

An embodiment of the present invention will be described below.

Embodiment 1

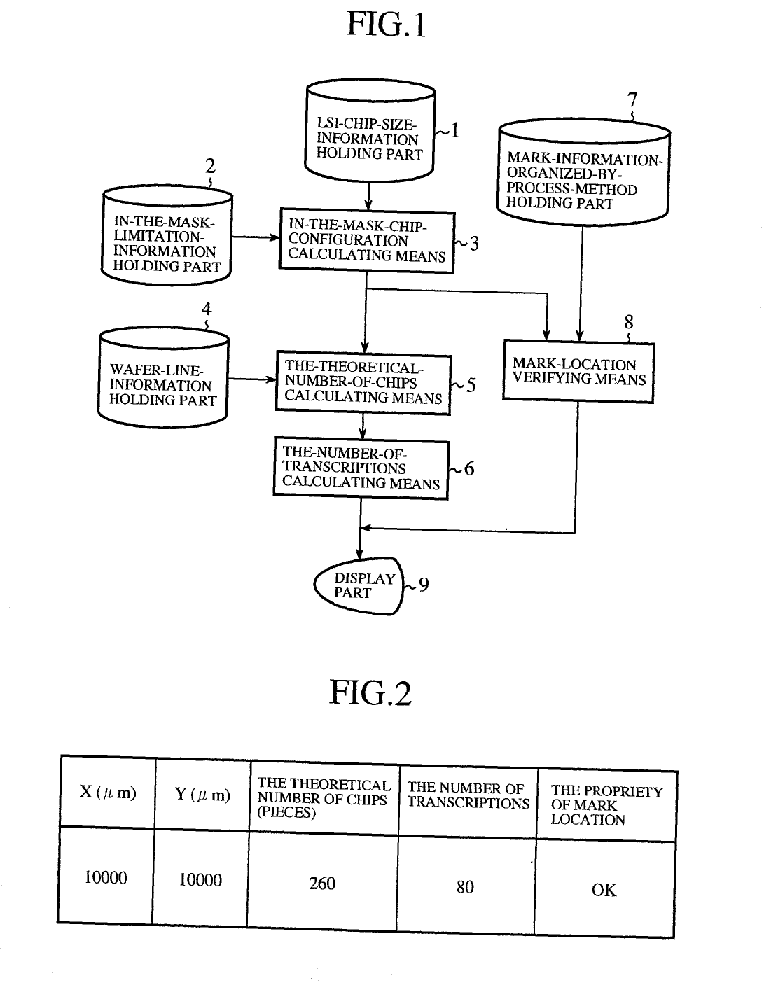

FIG. 1 is a configuration diagram showing the apparatus for determining the optimum size of a LSI chip according to Embodiment 1 of the present invention. Referring to the figure, LSI-chip-size-information holding part 1 has registered LSI chip sizes; in-the-mask-limitation-information holding part 2 holds the registered effective area in each mask size; in the-mask-chip-configuration calculating means 3 calculates a chip configuration in a mask; wafer-line-information holding part 4 holds the registered effective area in a wafer line to be used; and the-theoretical-number-of-chips calculating means 5 calculates the theoretical number of chips.

The-number-of-transcriptions calculating means 6 calculates the number of transcriptions of a layout pattern on a mask to a wafer; mark-information-organized-by-process-method holding part 7 holds the registered mark information organized by process method; mark-location verifying means 8 verifies the propriety of mark location; and display part 9 displays held information and a calculated result.

FIG. 2 is an explanatory diagram showing a display example displayed by the display part according to Embodiment 1 of the present invention.

The operation will next be described.

In the apparatus for determining the optimum size of a LSI chip shown in FIG. 1, in-the-mask-chip-configuration calculating means 3 inputs the size of the LSI chip, the name of the wafer line, and the size of the mask (for instance, 5-inch mask and 6-inch mask) from LSI-chip-size-information holding part 1, and inputs the effective area in each mask size (the area in the mask on which the transcription can be done) from in-the-mask-limitation-information holding part 2, respectively, to thereby calculate the chip configuration in the mask according to the size of the LSI chip, the size of the mask, and the effective area of the mask (The in-the-mask-chip-configuration calculating step). For instance, when the size of the LSI chip is 10000×10000 μm, and the in-the-mask limitation information is 25000×21000 μm (the usable area in a 6-inch mask), the chip configuration in the mask becomes 2×2 (The X direction: 25000÷10000=2.5, and the Y direction: 21000÷10000=2.1; the chip configuration becomes 2×2 by dropping the fractional portion of the number.).

Moreover, the-theoretical-number-of-chips calculating means 5 inputs the calculated chip configuration in the mask and the effective area in the wafer line (Because the usable area in a wafer is different depending on the wafer line to be used, the area is described in the information.) from wafer-line-information holding part 4. After determining the chip configuration in the wafer in the wafer line to be used, the-theoretical-number-of-chips calculating means 5 calculates the theoretical number of chips (the number of LSI chips) (The the-theoretical-number-of-chips calculating step).

In addition, the-number-of-transcriptions calculating means 6 inputs the chip configuration in the mask calculated by in-the-mask-chip-configuration calculating means 3 and the theoretical number of chips calculated by the-theoretical-number-of-chips calculating means 5, to thereby calculate how many times the transcription should be done by use of the chip configuration in the mask, that is, the number of transcriptions (The number of transcriptions calculating step).

Additionally, mark-location verifying means 8 inputs the chip configuration in the mask calculated by in-the-mask-chip-configuration calculating means 3, the name and the size of the mark for wafer processing, used for alignment, and the position for locating the mark in the mask, to be located on the dicing line organized by process method from mark-information-organized-by-process-method holding part 7, and thereby verifies the propriety of the mark locations by checking whether or not all of the marks for wafer processing can be located (The mark-location verifying step).

As shown in FIG. 2, display part 9 displays, for instance, the sizes (X, Y) of the LSI chip, the theoretical number of chips, the number of transcriptions, and the propriety of mark locations according to the above-described held information and the above-mentioned results of calculation, to thereby finish its job.

As mentioned above, according to Embodiment 1, because the theoretical number of chips, the number of transcriptions, and the propriety of mark locations are displayed based on the size of the LSI chip, the name of the wafer line, and the size of the mask, the designer can confirm the theoretical number of chips, the number of transcriptions, and the propriety of the mark locations.

By the way, it depends on (1) the results of reliability evaluation in the first stage of the development of the LSI chip, (2) the manufacturability thereof, and others whether priority is given to the theoretical number of chips or to the number of transcriptions (the throughput of wafer processing). If the marks for wafer processing cannot be located, the LSI cannot be produced.

Embodiment 2

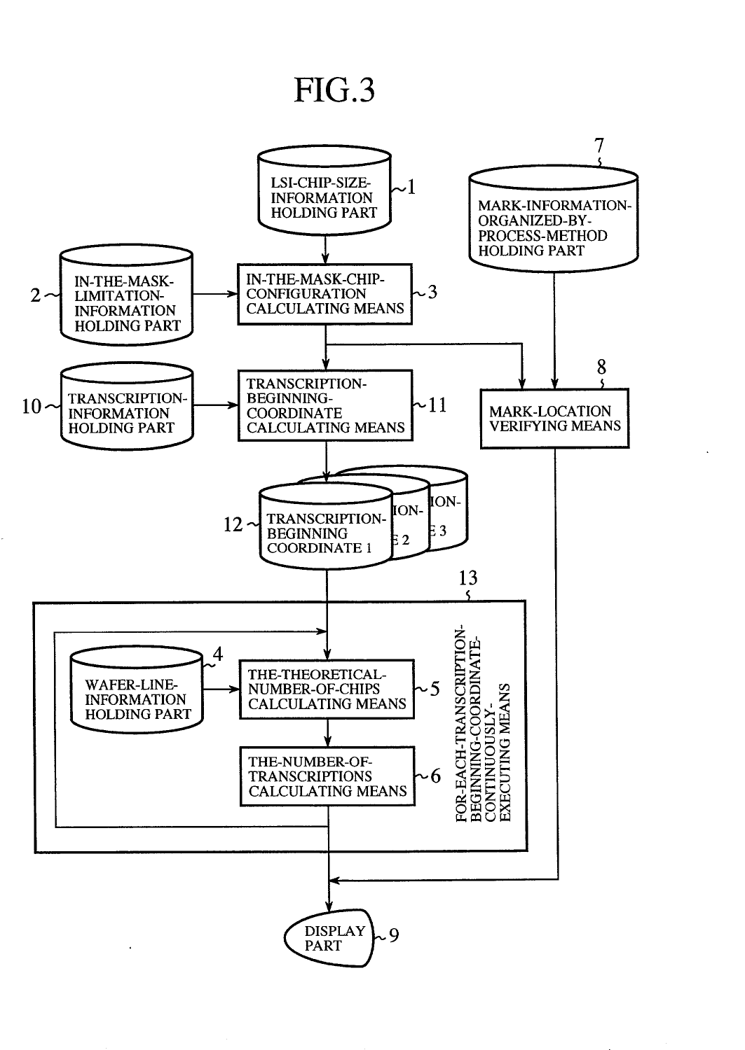

FIG. 3 is a configuration diagram showing the apparatus for determining the optimum size of a LSI chip according to Embodiment 2 of the present invention. Referring to the figure, transcription-information holding part 10 holds the registered maximum value, minimum value, and step value of a transcription beginning coordinate in a wafer, transcription-beginning-coordinate calculating means 11 calculates the transcription-beginning coordinate, transcription-beginning-coordinate holding part 12 holds those calculated transcription-beginning coordinates, and for-each-transcription-beginning-coordinate-continuously executing means 13 continuously executes the-theoretical-number-of-chips calculating means 5 and the-number-of-transcriptions calculating means 6 for each calculated transcription-beginning coordinate. For other constitutions, the figure is the same as FIG. 1.

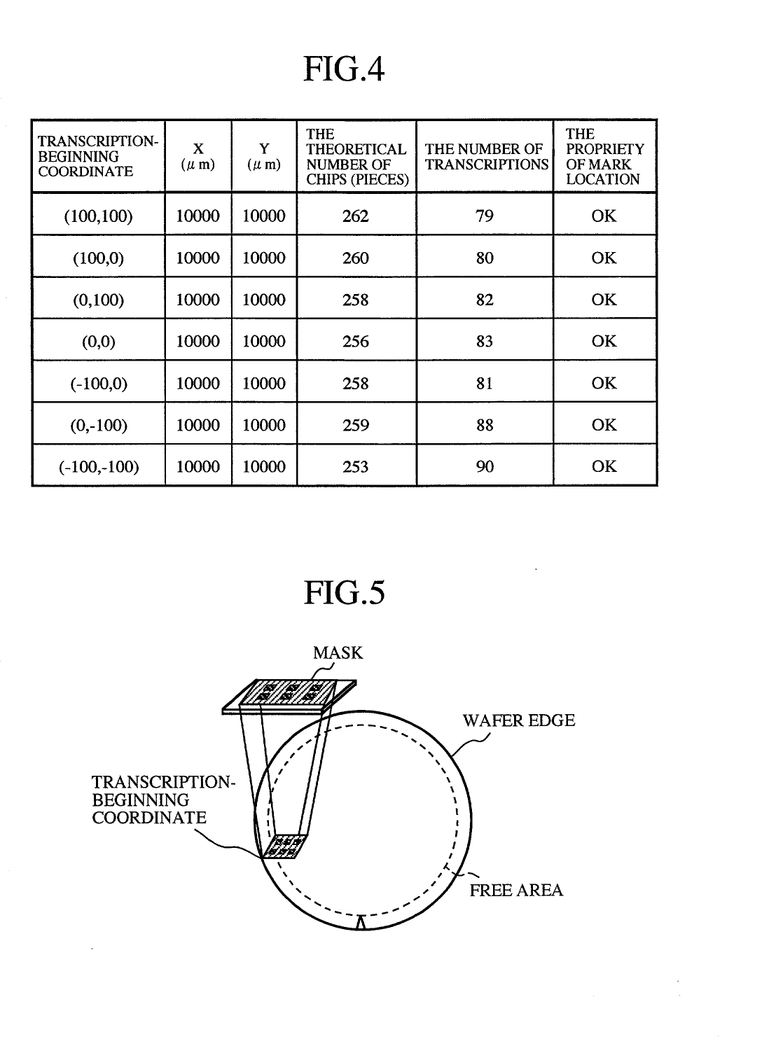

FIG. 4 is an explanatory diagram showing a display example displayed by the display part according to Embodiment 2 of the present invention. FIG. 5 is an explanatory drawing showing the relation between a wafer and a mask according to Embodiment 2 of the present invention.

The operation will next be described.

In the apparatus for determining the optimum size of a LSI chip shown in FIG. 3, in-the-mask-chip-configuration calculating means 3 calculates a chip configuration in a mask.

Transcription-beginning-coordinate calculating means 11 inputs the calculated chip configuration in the mask, the maximum value and minimum value (for instance, the maximum value: 100, 100, the minimum value: −100, −100) of the transcription-beginning coordinate in the wafer from transcription-information holding part 10, and the step value (for instance, 100 μm) for changing this coordinate, to thereby calculate the transcription-beginning coordinate in the wafer as shown in FIG. 5. For instance, when the maximum values of the transcription beginning coordinate are 100, 100, the minimum values are −100, −100, and the step value is 100 μm, (1) 100, 100, (2) 100, 0, (3) 0, 100, (4) 0, 0, (5) −100, 0, (6) 0, −100, and (7) −100, −100 are calculated for the transcription -beginning coordinate. The calculated transcription-beginning coordinates are held by transcription-beginning-coordinate holding part 12.

Subsequently, for-each-transcription-beginning-coordinate-continuously executing means 13 continuously executes the-theoretical-number-of-chips calculating means 5 and the-number-of-transcriptions calculating means 6 for each transcription-beginning coordinate held by transcription-beginning coordinate holding part 12, to thereby calculate the theoretical number of chips and the number of transcriptions for each transcription-beginning coordinate. Moreover, aside from for-each-transcription-beginning-coordinate-continuously executing means 13, mark-location verifying means 8 verifies whether or not all of the marks for wafer processing can be located, to thereby verify the propriety of the mark location.

As shown in FIG. 4, display part 9 displays, for instance, the transcription-beginning coordinates, the sizes (X, Y) of the LSI chip, the theoretical number of chips, the number of transcriptions, and the propriety of mark locations according to the above-described held information and the above-mentioned calculated results, to thereby finish its job.

As mentioned above, according to Embodiment 2, because the theoretical number of chips for each transcription position, the number of transcriptions, and the propriety of mark locations can be displayed based on the size of the LSI chip, the name of the wafer line, and the sizes of the mask, the designer can confirm which of the transcription positions is the best for the size of the LSI chip to be input.

Embodiment 3

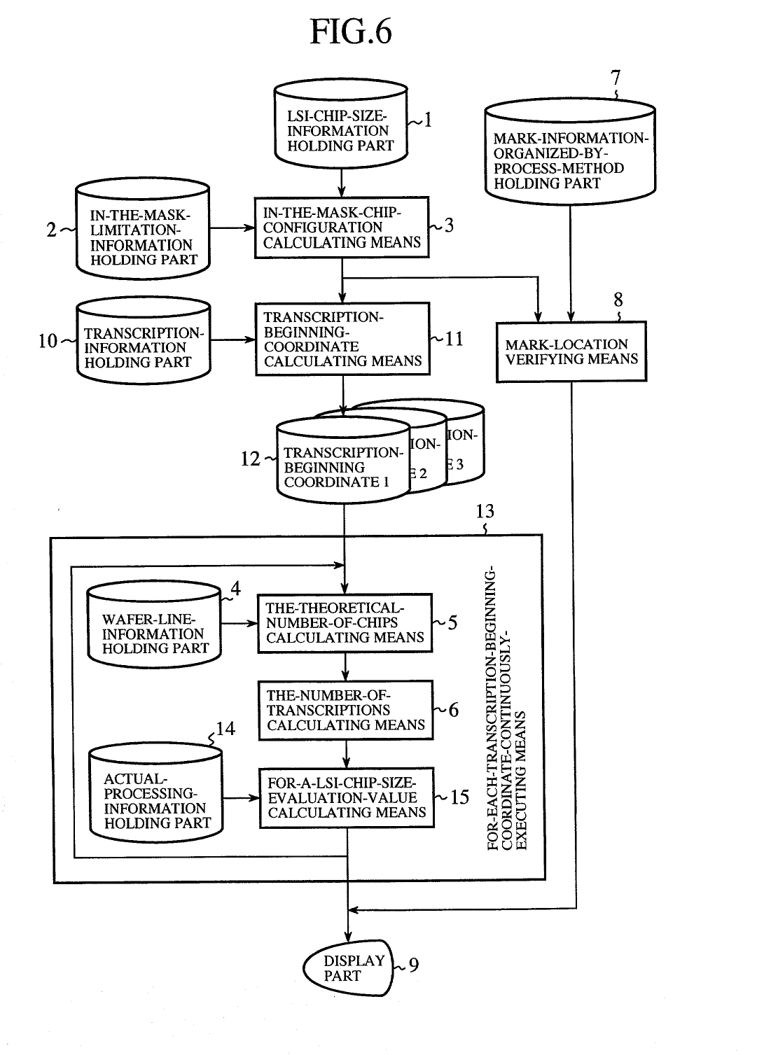

FIG. 6 is a configuration diagram showing the apparatus for determining the optimum size of a LSI chip according to Embodiment 3 of the present invention. Referring to the figure, actual-processing-information holding part 14 holds the registered processing time for each number of transcriptions and the registered ratio of the total cost of the wafer processing to the cost of the photolithography process, and for-a-LSI-chip-size-evaluation-value calculating means 15 calculates an evaluation value for judging whether or not the LSI chip size is the optimum one. For other constitutions, the figure is the same as FIG. 3.

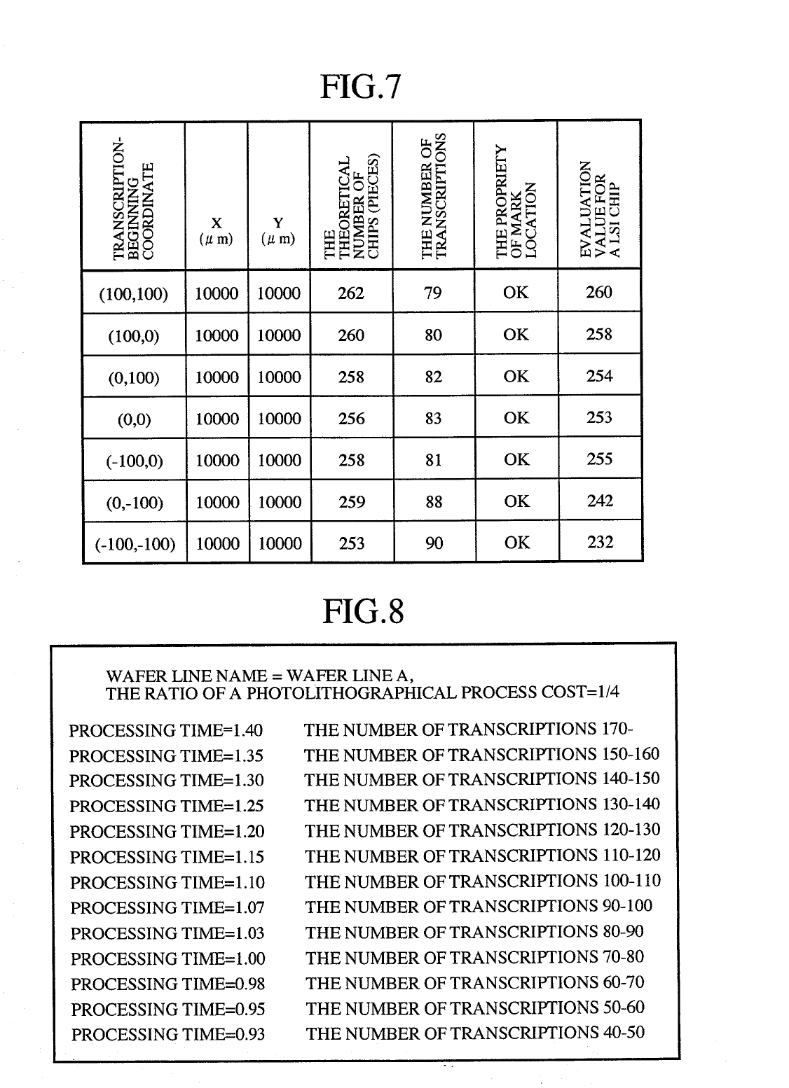

FIG. 7 is an explanatory diagram showing a display example displayed by the display part according to Embodiment 3 of the present invention. FIG. 8 is an explanatory diagram showing information on the actual processing according to Embodiment 3 of the present invention.

The operation will next be described.

In the apparatus for determining the optimum size of a LSI chip shown in FIG. 6, for-each-transcription-beginning-coordinate-continuously executing means 13 continuously executes the-theoretical-number-of-chips calculating means 5, the-number-of-transcriptions calculating means 6, and for-a-LSI-chip-size-evaluation-value calculating means 15 for each transcription-beginning coordinate held by transcription-beginning-coordinate holding part 12.

For-a-LSI-chip-size-evaluation-value calculating means 15 inputs the theoretical number of chips calculated by the-theoretical-number-of-chips calculating means 5, the number of transcriptions calculated by the-number-of-transcriptions calculating means 6, the processing time for each number of transcriptions shown in FIG. 8 from actual-processing-information holding part 14, and the ratio of the total cost of wafer processing to the cost of the photolithography process for each transcription-beginning coordinate, to thereby calculate an evaluation value from the following formula.

Evaluation value E=T×(1−Ca),

Ca=(C−1)×R,

C=0.5×(Ta+1),

where T represents a theoretical number of chips, R represents the ratio of the total cost of the wafer processing to the cost of the photolithography process (it is different depending on the actual production of the wafer line), and Ta represents a processing time obtained from the number of transcriptions (it is different depending on the actual production of the wafer line).

For instance, when the cost of the photolithography process accounts for ¼ of the total cost of the wafer processing, R is equal to 0.25. In the wafer line where the relative value is 1 when the number of transcriptions is 80, the evaluation value E is as follows when the size of the LSI chip is 1000×10000 μm.

By the way, the higher the evaluation value, the more suitable the size of the LSI chip becomes.

Evaluation value E=260,

Ta=1 (because the number of transcriptions is 80.),

C=0.5×(1+1),

Ca=(1−1)×0.25,

∴E=260×(1−0)

As shown in FIG. 7, display part 9 displays, for instance, the transcription-beginning coordinates, the sizes (X, Y) of the LSI chip, the theoretical number of chips, the number of transcriptions, the propriety of mark locations, and the evaluation value of the LSI chip according to the above-described held information and the above-mentioned calculated results, to thereby finish its job.

As mentioned above, according to Embodiment 3, because the theoretical number of chips for each transcription position, the number of transcriptions, the propriety of mark locations, and the evaluation value of the LSI chip are displayed based on the sizes of the LSI chip, the name of the wafer line, and the sizes of the mask, the designer can confirm the evaluation value in consideration of the theoretical number of chips and the throughput of wafer processing for the LSI chip size to be input.

Embodiment 4

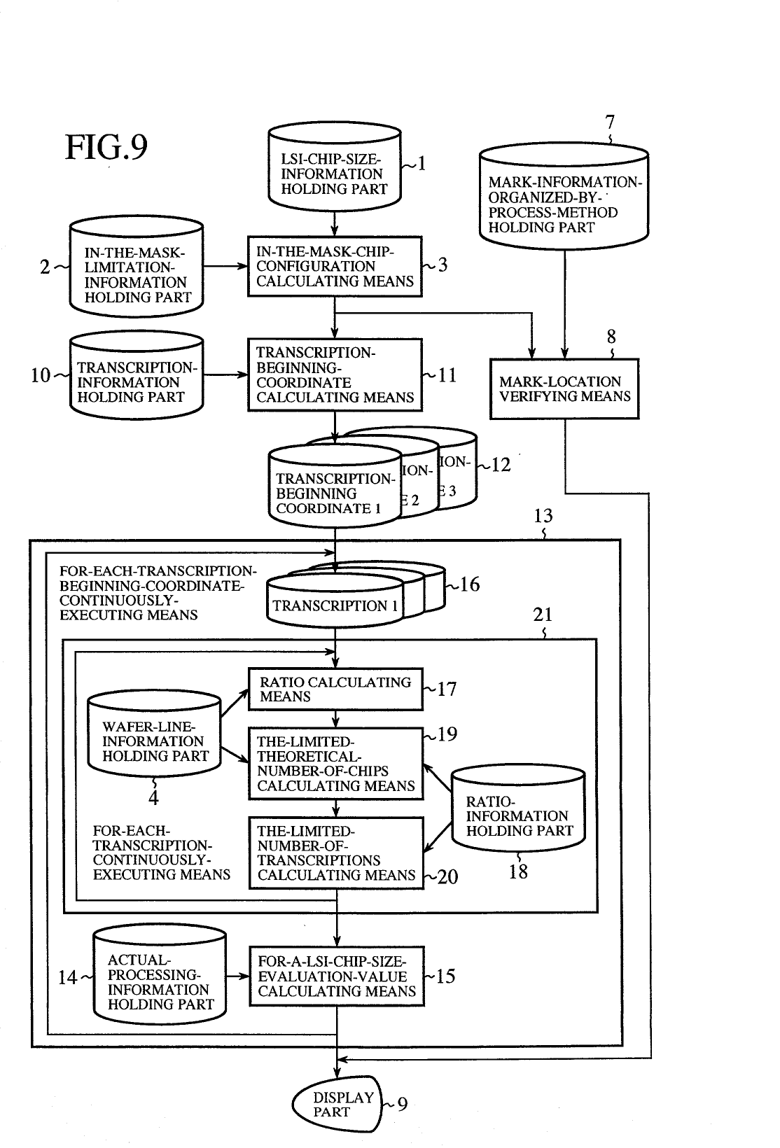

FIG. 9 is a configuration diagram showing the apparatus for determining the optimum size of a LSI chip according to Embodiment 4 of the present invention. Referring to the figure, transcription-information holding part 16 holds transcription information for each transcription-beginning coordinates held by transcription-beginning-coordinate holding part 12, ratio calculating means 17 calculates the ratio of the number of LSI chips in the mask to the number of LSI chips where the problem is caused in the wafer, ratio-information holding part 18 holds the registered ratio information, the-limited-theoretical-number-of-chips calculating means 19 limits the theoretical number of chips according to the calculated ratio and the ratio information, to thereby calculate the limited theoretical number of chips, the-limited-number-of-transcriptions calculating means 20 limits the number of transcriptions according to the calculated ratio and the ratio information, to thereby calculate the limited number of transcriptions, and for-each-transcription-continuously-executing means 21 continuously executes ratio calculating means 17, the-limited-theoretical-number-of-chips calculating means 19, and the-limited-number-of-transcriptions calculating means 20 for each transcription. For other constitutions, the figure is the same as FIG. 6.

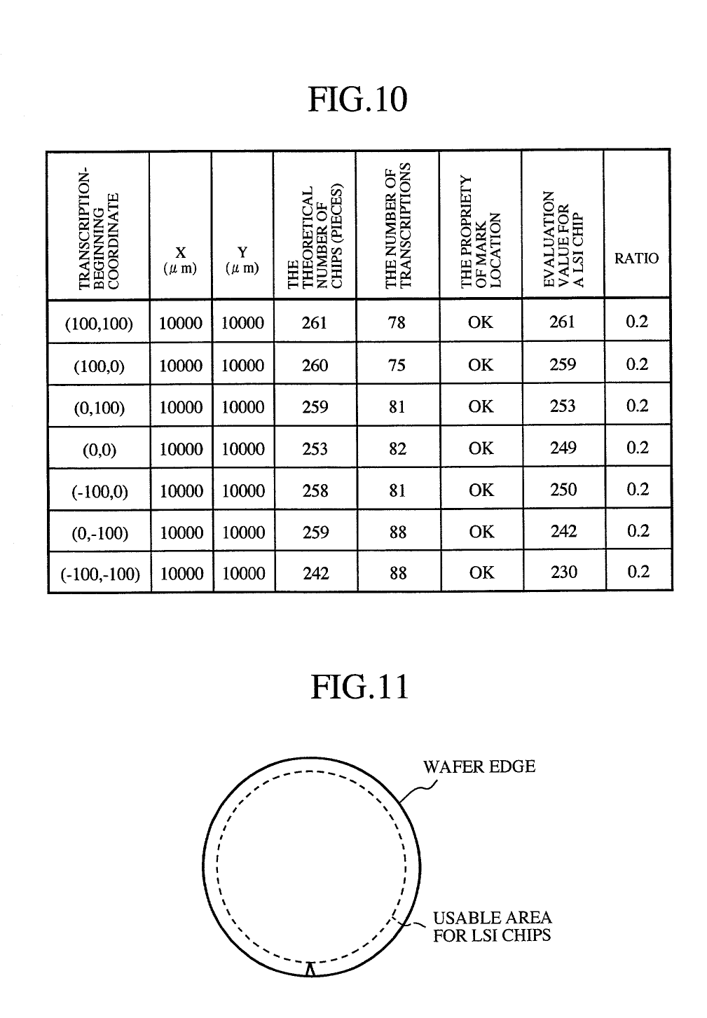

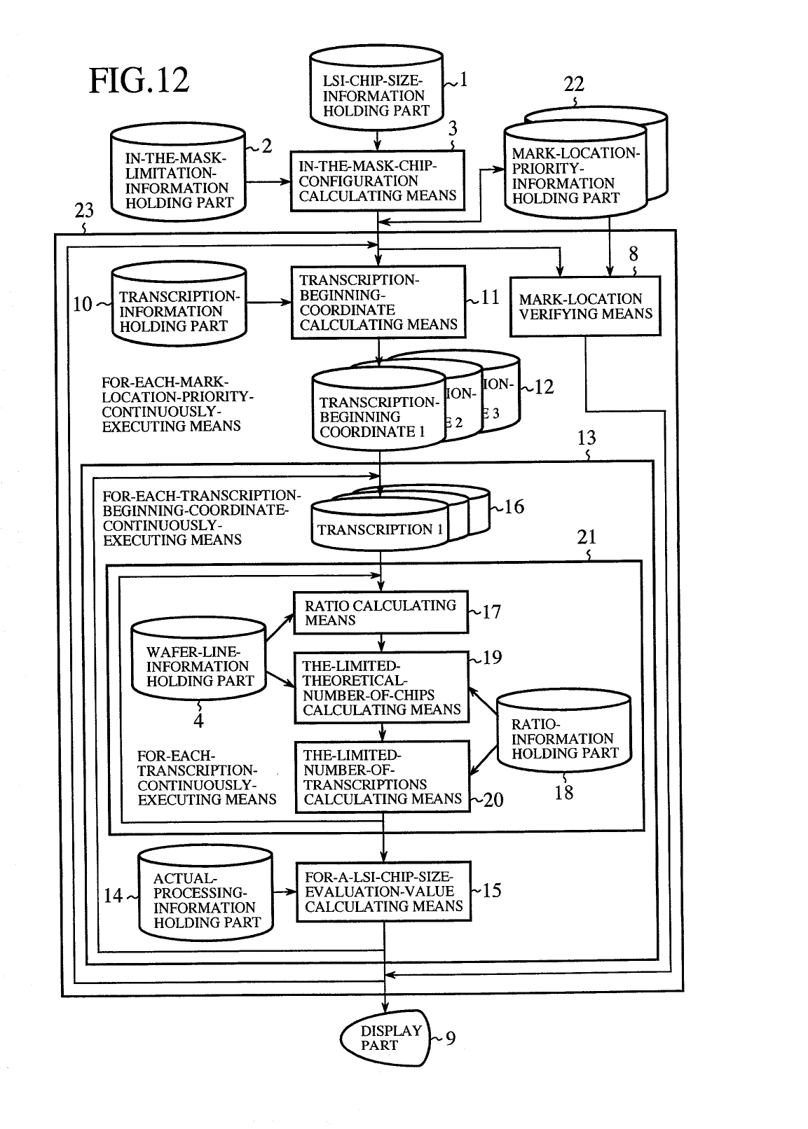

FIG. 10 is an explanatory diagram showing a display example displayed by the display part according to Embodiment 4 of the present invention. FIG. 11 is an explanatory drawing showing a wafer sample according to Embodiment 4 of the present invention.

The operation will next be described.

In the apparatus for determining the optimum size of a LSI chip shown in FIG. 9, for-each-transcription-beginning-coordinate-continuously executing means 13 continuously executes for-each-transcription-continuously-executing means 21 and for-a-LSI-chip-size-evaluation-value calculating means 15 for each transcription-beginning coordinate held by transcription-beginning-coordinate holding part 12.

At this time, the-limited-theoretical-number-of-chips calculating means 19 and the-limited-number-of-transcriptions calculating means 20 are executed for each transcription-beginning coordinate held by transcription-beginning-coordinate holding part 12, and thereby transcription-information holding part 16, first of all, holds transcription information that becomes each coordinate when transcriptions were done a plurality of times for each transcription-beginning coordinate from those calculated results. It is all that is needed to have provided the function for calculating this transcription information in the-limited-number-of-transcriptions calculating means 20.

Afterwards, for-each-transcription-continuously-executing means 21 continuously executes ratio calculating means 17, the-limited-theoretical-number-of-chips calculating means 19, and the-limited-number-of-transcriptions calculating means 20 for each transcription held by transcription-information holding part 16.

By the way, in-the-mask-chip-configuration calculating means 3 calculates the chip configuration in the mask, and also the number (N) of LSI chips in the mask.

Ratio calculating means 17 inputs the chip configuration in the mask calculated by in-the-mask-chip-configuration calculating means 3 and the effective area in the wafer line from wafer-line-information holding part 4 (Because the usable area in a wafer is different depending on the wafer line to be used, the area is described in the information.), to thereby calculate the number (X) of LSI chips in the wafer where the problem is caused for a LSI chip when the transcription from the mask to the wafer is done (because the shape of the wafer is round, the part in the wafer that cannot be used for the LSI chip is produced because of the partial lack in the layout pattern when the transcription from the mask to the edge of the wafer is done), and additionally calculate the ratio (X/N) of the number (N) of LSI chips in the mask calculated by in the-mask-chip-configuration calculating means 3 to the number (X) of LSI chips in the wafer where the problem is caused.

The-limited-theoretical-number-of-chips-calculating means 19 inputs the calculated ratio X/N and the ratio (P) for determining whether or not the transcription is done from ratio-information holding part 18, and calculates the limited number of chips by limiting the theoretical number of chips not to do the transcription when P<X/N. Moreover, the-limited-number-of-transcriptions calculating means 20 similarly calculates the limited number of transcription by limiting the number of transcriptions not to do the transcription when P<X/N.

For instance, when the ratio (P) for determining whether or not the transcription is done is 0.2, the number (N) of LSI chips in the mask is 10, and the number (X) of LSI chips in the wafer where the problem is caused for a LSI chip is 3 or 2 due to the transcription on the edge of the wafer because an area in the wafer that can be used for LSI chips is limited by the limitation in the wafer line as shown in FIG. 11 (For instance, in the area on the wafer line, the area of 3 mm from the wafer edge cannot be used), the transcription is not performed. However, when X is one, the transcription is performed.

As shown in FIG. 10, display part 9 displays, for instance, the transcription-beginning coordinates, the sizes (X, Y) of the LSI chip, the theoretical number of chips and the number of transcriptions in consideration of the number of LSI chips in the wafer in which a problem is caused for a LSI chip, further the propriety of mark locations, the evaluation value of the LSI chip, and the ratio (P) according to the above-described held information and the above-mentioned calculated results, to thereby finish its job.

As mentioned above, according to Embodiment 4, the designer can confirm the theoretical number of chips and the number of transcriptions in consideration of the number of LSI chips in the wafer in which a problem is caused for a LSI chip for each transcription-beginning coordinate from the size of the LSI chip, the name of the wafer line, and the size of the mask. As a result, the designer can confirm the theoretical number of chips and the number of transcriptions from which the unnecessary transcription in the wafer line to be input was optionally deleted.

Embodiment 5

FIG. 12 is a configuration diagram showing the apparatus for determining the optimum size of a LSI chip according to Embodiment 5 of the present invention. Referring to the figure, mark-location-priority-information holding part 22 holds the registered priority of mark location for wafer processing, number of marks for process organized by process method, and sizes of marks, and for-each-mark-location-priority-continuously-executing means 23 continuously executes transcription-beginning-coordinate calculating means 11, for-each-transcription-beginning-coordinate-continuously-executing means 13, and mark-location verifying means 8 for each priority of the mark location for wafer processing. For other constitutions, the figure is the same as FIG. 9.

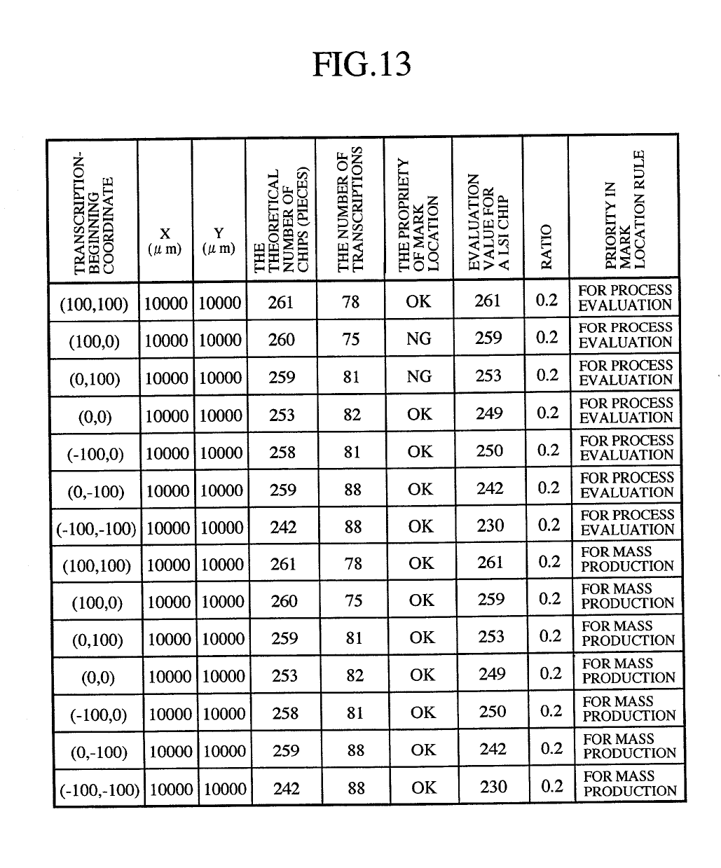

FIG. 13 is an explanatory diagram showing a display example displayed by the display part according to Embodiment 5 of the present invention.

The operation will next be described.

In the apparatus for determining the optimum size of a LSI chip shown in FIG. 12, mark-location-priority-information holding part 22 holds the registered names of the marks, number of the marks, sizes of the marks, and location positions of the marks in the mask organized by process method for each priority of the mark locations (for instance, (1) the mark location for process development, (2) the mark location for mass production), and for-each-mark-location-priority-continuously-executing 23 continuously executes transcription-beginning-coordinate calculating means 11, for-each-transcription-beginning-coordinate-continuously executing means 13 (including for-each-transcription-continuously-executing means 21, and for-a-LSI-chip-size-evaluation-value calculating means 15), and mark-location verifying means 8 for each priority of the mark locations.

As shown in FIG. 13, display part 9 displays, for instance, the transcription-beginning coordinates, the sizes (X, Y) of the LSI chip, the theoretical number of chips, the number of transcriptions, the propriety of mark locations, the evaluation value of the LSI chip, the ratio, and the priority in the mark location rule according to the above-described held information and the above-mentioned calculated results, to thereby finish its job.

As mentioned above, according to Embodiment 5, the designer can confirm the theoretical number of chips, the number of transcriptions, the evaluation value for the LSI chip size, and the propriety of mark locations for each priority in the mark location in consideration of the number of LSI chips in the wafer in which a problem is caused for a LSI chip for each position of transcription from the size of the LSI chip, the name of the wafer line, and the size of the mask. As a result, the designer can confirm, for instance, the propriety of mark locations for wafer processing that are suitable for process development or mass production, to thereby achieve the object of the LSI development.

Embodiment 6

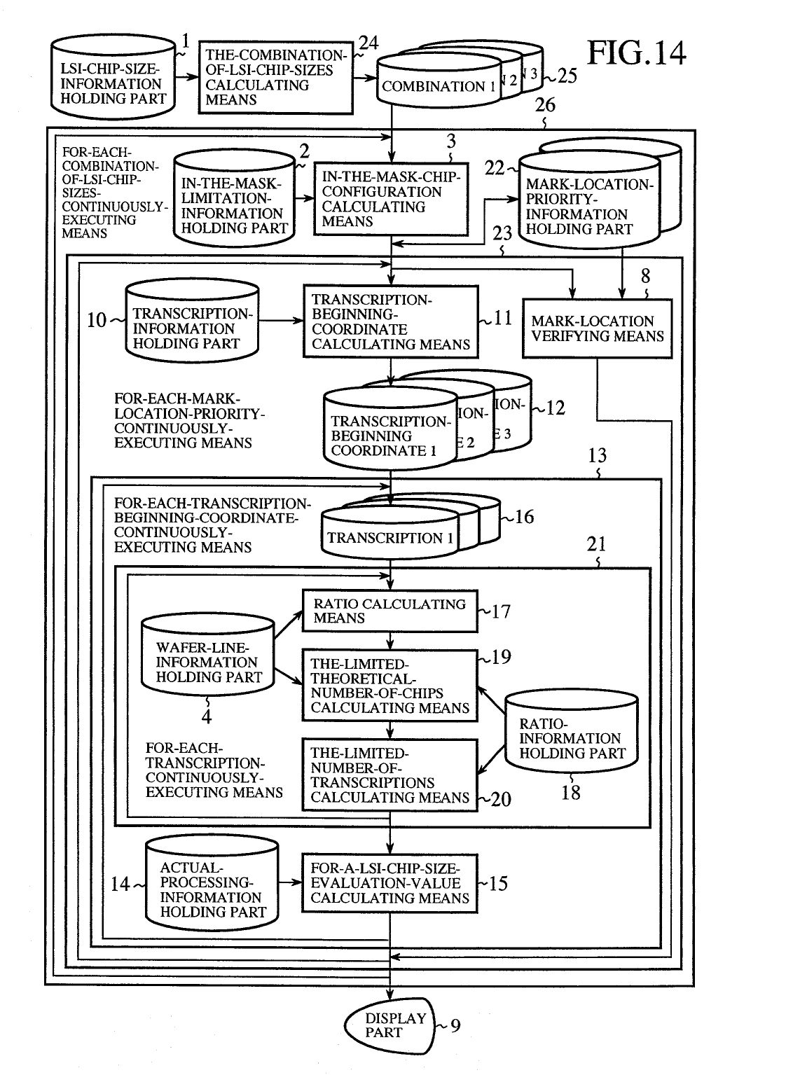

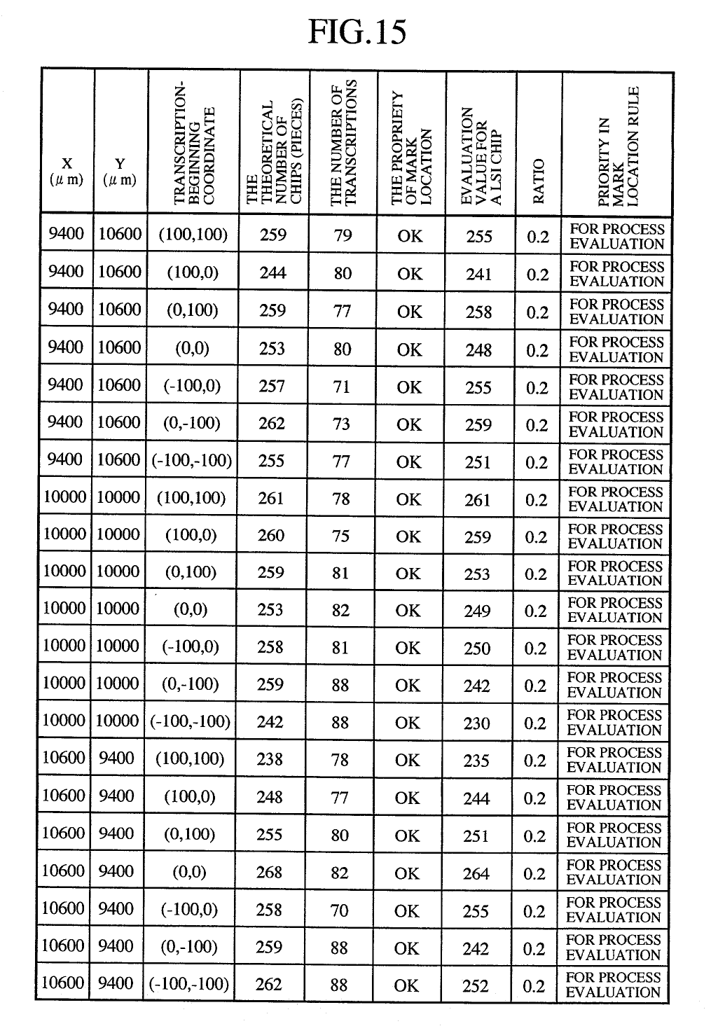

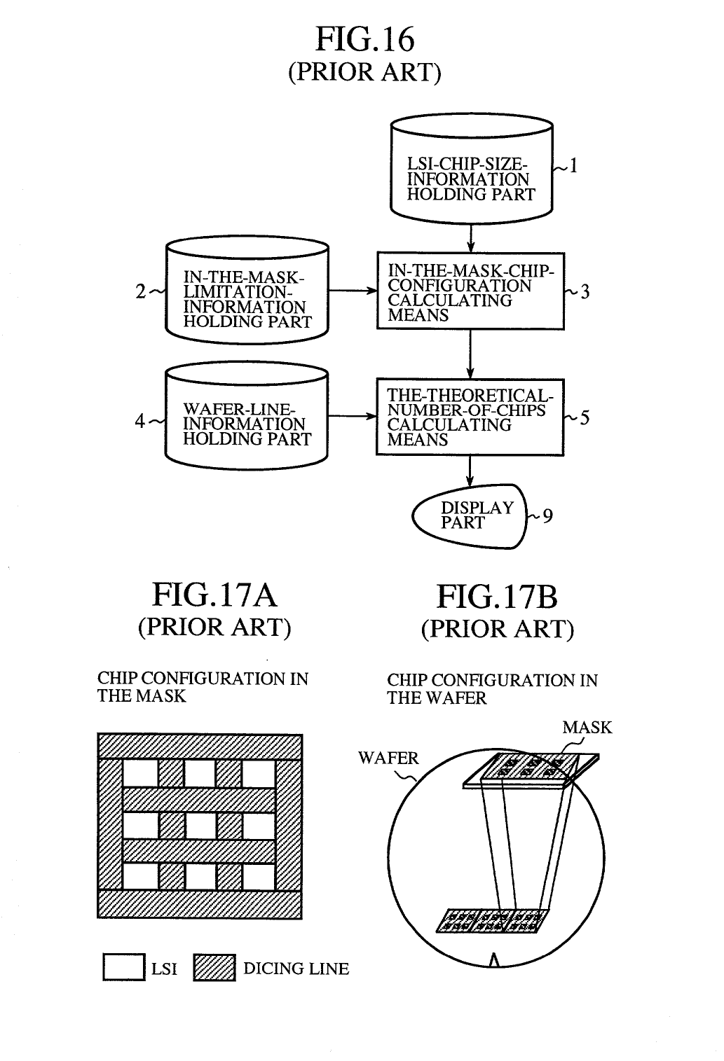

FIG. 14 is a configuration diagram showing the apparatus for determining the optimum size of a LSI chip according to Embodiment 6 of the present invention. Referring to the figure, the-combination-of-LSI-chip-sizes calculating means 24 calculates the combination of LSI chip sizes; the-combination-of-LSI-chip-sizes-information holding part 25 holds the calculated combination of LSI chip sizes; and for-each-combination-of-LSI-chip-sizes-continuously-executing means 26 continuously executes in-the-mask-chip-configuration calculating means 3 and for-each-mark-location-priority-continuously-executing means 23 for each calculated combination of LSI chip sizes. For other constitutions, the figure is the same as FIG. 12.

FIG. 15 is an explanatory diagram showing a display example displayed by the display part according to Embodiment 6 of the present invention.

The operation will next be described.

In the apparatus for determining the optimum size of a LSI chip shown in FIG. 14, LSI-chip-size-information holding part 1 holds the registered maximum value, minimum value, and step value of LSI chip sizes. The-combination-of-LSI-chip-sizes calculating means 24 inputs the maximum value, minimum value, and step value of LSI chip sizes from LSI-chip-size-information holding part 1, to thereby calculate the combination of LSI chip sizes. For instance, when the minimum value of the LSI chip size is 9400×9400 μm, the maximum value thereof is 10600×10600 μm, and the step value thereof is 600 μm, the combinations of the LSI chip sizes are (1) 100000×10000 μm, (2) 10600×9400 μm, and (3) 9400×10600 μm. Since many LSI chips have a memory part having a determined area and a logic part having a determined area, the combination such that the LSI chip area is constant is calculated. The-combination-of-LSI-chip-sizes-information holding part 25 holds those calculated combinations of LSI chip sizes. For-each-combination-of-LSI-chip-sizes-continuously-executing means 26 continuously executes in-the-mask-chip-configuration calculating means 3 and for-each-mark-location-priority-continuously-executing means 23 for each calculated combination of LSI chip sizes.

As shown in FIG. 15, display part 9 displays, for instance, the combination of LSI chip sizes (X, Y), the transcription-beginning coordinate, the theoretical number of chips, the number of transcriptions, the propriety of mark location, the evaluation value of the LSI chip, the ratio, and the priority in the mark location rule according to the above-described held information and the above-mentioned calculated results, to thereby finish its job.

As mentioned above, according to Embodiment 6, the designer can confirm the theoretical number of chips, the number of transcriptions, the evaluation value for the LSI chip size, and the propriety of mark location for each priority in the mark location for each combination of LSI chip sizes from the maximum and the minimum values of the LSI chip size, the step value, the name of the wafer line, and the size of the mask. As a result, the designer can easily confirm and determine the optimum size of a LSI chip in consideration of the theoretical number of chips and the throughput of wafer processing by onetime use of the apparatus.

As mentioned above, according to the present invention, because the method of determining the optimum size of a LSI chip is constructed to comprise a the-number-of-transcriptions calculating step in which the number of the transcriptions of a layout pattern on the mask to a wafer is calculated according to the chip configuration in the mask calculated in the in the-mask-chip-configuration calculating step and the theoretical number of chips calculated in the the-theoretical-number-of-chips calculating step; and a mark-location verifying step in which the propriety of mark location is verified according to the chip configuration in the mask calculated in the in-the-mask-chip-configuration calculating step and mark information organized by processing method, the effect that the designer can confirm the size of a LSI chip, the theoretical number of chips, the number of transcriptions, and the propriety of the mark location.

According to the present invention, because the apparatus for determining the optimum size of a LSI chip is constructed to comprise a the-number-of-transcriptions calculating means calculating the number of transcriptions of a layout pattern on the mask to the wafer according to the chip configuration in the mask calculated by the in-the-mask-chip-configuration calculating means and the theoretical number of chips calculated by the the-theoretical-number-of-chips calculating means; a mark-location verifying means verifying the propriety of a mark location according to the chip configuration in the mask calculated by the in-the-mask-chip-configuration calculating means and information in a mark-information-organized-by-processing-method holding part; and a display part displaying any one of the above-described held information and the above-described calculated or verified result, the effect that the designer can confirm the size of a LSI chip, the theoretical number of chips, the number of transcriptions, and the propriety of the mark location.

According to the present invention, because the apparatus for determining the optimum size of a LSI chip is constructed to comprise a transcription-information holding part in which the maximum value, the minimum value, and the step value of a transcription beginning coordinate in a wafer are registered; a transcription-beginning-coordinate calculating means calculating a transcription beginning coordinate according to a chip configuration in a mask calculated by the in-the-mask-chip-configuration calculating means and the information in the transcription-information holding part; and a for-each-transcription-beginning-coordinate continuously executing means continuously executing the the-theoretical-number-of-chips calculating means and the the-number-of-transcriptions calculating means for each transcription beginning coordinate calculated by the transcription-beginning-coordinate calculating means, the designer can confirm the theoretical number of chips and the number of transcriptions for each position of the transcription. As a result, the effect that the designer can confirm which of the positions of the transcriptions is the optimum one in the size of a LSI chip to be input is obtained.

According to the present invention, because the apparatus for determining the optimum size of a LSI chip is constructed to comprise an actual-processing-information holding part in which a processing time for each transcription and the ratio of the total cost of the wafer processing to the cost of the photolithography process are registered; and a for-a-LSI-chip-size-evaluation-value calculating means calculating an evaluation value according to the theoretical number of chips calculated by the the-theoretical-number-of-chips calculating means, the number of transcriptions calculated by the the-number-of-transcriptions calculating means, and the information in the actual-processing-information holding part, the designer can confirm the theoretical number of chips, the number of transcriptions, the propriety of the mark location, and the evaluation value for each position of the transcription. As a result, the effect that the designer can confirm the evaluation value in consideration of the theoretical number of chips and the throughput of wafer processing in the size of a LSI chip to be input is obtained.

According to the present invention, because the apparatus for determining the optimum size of a LSI chip is constructed to comprise a ratio calculating means calculating the number of LSI chips in the wafer in which a problem for a LSI chip is caused when a transcription from a mask to a wafer is done according to a chip configuration in a mask calculated by the in-the-mask-chip-configuration calculating means and the information in the wafer-line-information holding part, to thereby calculate the ratio of the number of LSI chips in the mask to the number of LSI chips in the wafer in which the problem is caused; a ratio-information holding part in which the ratio information is registered; a the-limited-theoretical-number-of-chips calculating means calculating the theoretical number of chips within the limits according to the ratio calculated by the ratio calculating means and the information in the ratio-information holding part; a the-limited-number-of-transcriptions calculating means calculating the number of transcriptions within the limits according to the ratio calculated by the ratio calculating means and the information in the ratio-information holding part; and a for-each-transcription-continuously-executing means continuously executing the ratio calculating means, the the-limited-theoretical-number-of-chips calculating means, and the the-limited-number-of-transcriptions calculating means for each transcription, the designer can confirm the theoretical number of chips and the number of transcriptions in consideration of the number of LSI chips in the wafer in which a problem is caused for a LSI chip for each transcription beginning coordinate. As a result, the effect that the designer can confirm the theoretical number of chips and the number of transcriptions from which the unnecessary transcription on the wafer line to be input was optionally deleted.

According to the present invention, because the apparatus for determining the optimum size of a LSI chip is constructed to comprise a mark-location-priority-information holding part in which the priority of mark location for wafer processing, the number of marks for processing organized by process method, and the mark sizes are registered; and a for-each-mark-location-priority-continuously-executing means continuously executing the transcription-beginning-coordinate calculating means, the for-each-transcription-continuously-executing means, the for-a-LSI-chip-size-evaluation-value calculating means, and the mark-location verifying means for each priority in the mark location for wafer processing registered in the mark-location-priority-information holding part, the designer can confirm the theoretical number of chips, the number of transcriptions, the evaluation value for the LSI chip size, and the propriety of mark location for each priority in the mark location in consideration of the number of LSI chips in the wafer in which a problem is caused for a LSI chip for each position of transcription. As a result, the effect that the designer can confirm, for instance, the propriety of mark locations for wafer processing that are suitable for process development or mass production, to thereby achieve the object of the LSI development is obtained.

According to the present invention, because the apparatus for determining the optimum size of a LSI chip is constructed to comprise a the-combination-of-LSI-chip-sizes calculating means calculating the combination of LSI chip sizes according to the maximum value and the minimum value of LSI chip sizes, and the step values of LSI chips; and a for-each-combination-of-LSI-chip-sizes continuously-executing means continuously executing the in the-mask-chip-configuration calculating means and the for-each-mark-location-priority-continuously-executing means for each combination of LSI chip sizes calculated by the the-combination-of-LSI-chip-sizes calculating means, the designer can confirm the theoretical number of chips, the number of transcriptions, the evaluation value for the LSI chip size, and the propriety of mark locations for each priority in the mark location for each combination of LSI chip sizes. As a result, the effect that the designer can easily confirm and determine the optimum size of a LSI chip in consideration of the theoretical number of chips and the throughput of wafer processing by one-time use of the apparatus is obtained.

What is claimed is:

1. A method of determining the optimum size of an LSI chip, comprising the steps of:
calculating chip configurations formed on a mask based on information about LSI chip sizes;
calculating the theoretical number of chips based on the chip configurations formed on the mask obtained by said calculation of the chip configurations on the mask and on information about wafer lines;
calculating the number of transcriptions of layout patterns written on the mask to the wafer based on the chip configurations on the mask obtained by said calculation of the chip configurations on the mask and on the theoretical number of chips obtained by said calculation of the theoretical number of chips; and
verifying a mark location verified based on the chip configurations on the mask obtained by said calculation of the chip configurations on the mask and on mark information by processing method.

2. An apparatus for determining the optimum size of an LSI chip, comprising:
chip-configuration calculating means for calculating chip configurations formed on a mask based on information stored in an LSI-chip-size-information holding part;
theoretical-number-of-chips calculating means for calculating theoretical number of chips based on the chip configurations on the mask obtained by said chip-configuration calculating means and on information stored in an wafer-line-information holding part;
number-of-transcriptions calculating means for calculating the number of transcriptions of layout patterns written on the mask to the wafer based on the chip configurations on the mask obtained by said chip-configuration calculating means and on the theoretical number of chips obtained by said theoretical-number-of-chips calculating means;
mark-location verifying means for verifying whether a mark location is right or wrong based on the chip configurations on the mask obtained by said chip-configuration calculating means and on information stored in a mark-information holding part for holding mark information by processing method; and
a display part for displaying any one of the held information and the calculated or verified result.

3. The apparatus for determining the optimum size of an LSI chip according to claim 2, comprising:
a transcription-information holding part for holding the maximum value, the minimum value, and the step value of a transcription beginning coordinate on the wafer;
coordinate calculating means for calculating the transcription beginning coordinate based on chip configurations on the mask obtained by said chip-configuration calculating means and on the information stored in said transcription-information holding part; and
first repeatedly executing means for repeatedly executing said theoretical-number-of-chips calculating means and the said number-of-transcriptions calculating means for each transcription beginning coordinate obtained by said coordinate calculating means.

4. The apparatus for determining the optimum size of an LSI chip according to claim 3, comprising:
an actual-processing-information holding part for holding processing times for each transcription and ratio of the total costs of the wafer processing to the costs of the photolithography process; and
evaluation-value calculating means for calculating an evaluation value of the LSI chip sizes from the following formulas based on the theoretical number of chips obtained by said theoretical-number-of-chips calculating means and the number of transcriptions obtained by said number-of-transcriptions calculating means, and on the information stored in the actual-processing-information holding part:
Evaluation value E=T×(1−Ca),
Ca=(C−1)×R,
C=0.5×(Ta+1),
where T represents a theoretical number of chips, R represents the ratio of the total cost of the wafer processing to the cost of the photolithography process, and Ta represents a processing time obtained from the number of transcriptions.

5. The apparatus for determining the optimum size of an LSI chip according to claim 4, comprising:
ratio calculating means for calculating the number of suspected LSI chips on the wafer involving a problem which is caused when a transcription from the mask to the wafer is done based on chip configurations on the mask obtained by said chip-configuration calculating means and on the information stored in an wafer-line-information holding part, and for calculating the ratio of the number of LSI chips on the mask to the number of suspected LSI chips on the wafer;
a ratio-information holding part for holding the ratio information;
theoretical-number-of-chips calculating means for calculating the theoretical number of chips within the limits based on the ratio obtained by said ratio calculating means and on the information stored in said ratio-information holding part;
number-of-transcriptions calculating means for calculating the number of transcriptions within the limits based on the ratio obtained by said ratio calculating means and on the information stored in said ratio-information holding part; and
second repeatedly executing means for repeatedly executing said ratio calculating means, said theoretical-number-of-chips calculating means, and said number-of-transcriptions calculating means for each transcription.

6. The apparatus for determining the optimum size of an LSI chip according to claim 5, comprising:
priority-information holding part for holding the priority of the mark location for wafer processing, the number of marks by processing method, and the mark sizes; and
third repeatedly executing means for repeatedly executing said coordinate calculating means, said second repeatedly executing means, said evaluation-value calculating means, and said mark-location verifying means for each priority in the mark location for wafer processing stored in said priority-information holding part.

7. The apparatus for determining the optimum size of an LSI chip according to claim 6, comprising:
combination calculating means for calculating the combination of the LSI chip sizes based on the maximum value, the minimum value of the LSI chip sizes, and the step values of LSI chips; and
forth repeatedly executing means for repeatedly executing said chip-configuration calculating means and said third repeatedly executing means for each combination of the LSI chip sizes obtained by said combination calculating means.
